(19) United States
(12) Patent Application Publication
(10) Pub. No.: US 2007/0273556 A1
(43) Pub. Date: Nov. 29, 2007

(54) System and method for adjusting the volume of an audible indication

(75) Inventors: Mike G. Gyde, Phoenix, AZ (US); John A. Howell, New River, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/441,840

(22) Filed: May 26, 2006

(51) Int. Cl. G08B 21/00

(52) U.S. Cl. 340/945

(57) ABSTRACT

A system and method for a vehicle adjusts the volume of an audible indication. An operational state of the vehicle is determined. The audible volume at which the audible indication is provided to the operator is varied based at least in part on said determined operational state of the vehicle.

### TECHNICAL FIELD

The present invention relates to a vehicle audio system, and more particularly, to a system and method for adjusting the volume of an audible indication to a user of the vehicle.

### BACKGROUND

Many modern vehicles, such as aircraft, are equipped with a wide variety of electrical and computing systems that monitor and, in some instances, control various operational aspects of the aircraft. One of the tasks performed by these systems is to monitor for potentially significant situations (e.g., low fuel and overspeed), and then warn the operator (e.g., the pilot), or other user, that the vehicle is in such a situation. A common method for alerting the operator of such situations is known as an aural warning.

On aircraft, aural warnings are audible signals or messages that are sounded within the flight deck when the aircraft is in a particular situation. Typically, aural warnings are emitted from speakers mounted within the flight deck, separate from the equipment used by the pilot for radio communication (e.g., a communications radio and headset). This configuration helps to ensure that the signal is heard regardless of whether or not the pilot is wearing the headset. Additionally, the volume at which aural warnings are emitted is typically set to a very high level to ensure that such a warning is heard by the pilot when the ambient noise level in on the flight deck is high.

However, due to the wide variety of conditions an aircraft may experience, the ambient noise level on the flight deck may vary considerably. For example, when the aircraft is on the ground with the engines idling (or not running), the ambient noise level on the flight deck is relatively low, but at high altitudes and speeds, with the engines at full throttle, the ambient noise level can reach relatively high levels.

The pre-set high volume of the aural warnings works well most notably when the ambient noise in the cockpit is high. However, at low ambient noise levels, such a loud aural warning can be potentially startling and uncomfortable for the pilot and any others on the flight deck, as well as those in the passenger compartment of the aircraft. Furthermore, some aviation regulatory authorities may not allow the aural warning system to include a volume control for the pilot to ensure that the aural warnings are heard at the high ambient noise levels.

Accordingly, it is desirable to provide a system and method for adjusting the volume of an audible indication, such as an aural warning. In addition, it is desirable to provide such a system and method in a reliable manner. Furthermore, other desirable features and characteristics of the present invention will become apparent from the subsequent detailed description and the appended claims, taken in conjunction with the accompanying drawings and the foregoing technical field and background.

### BRIEF SUMMARY

A method for providing an audible indication to an operator of a vehicle is provided. An operational state of the vehicle is determined. The audible volume at which the audible indication is provided to the operator is varied based at least in part on said determined operational state of the vehicle.

An avionics system is provided. A speaker is mounted on a flight deck of an aircraft to provide an audible indication to an operator of the aircraft. A gain amplifier is coupled to the speaker to provide a gain to an audio signal provided to the speaker. A processor is in operable communication with the speaker and the gain amplifier. The processor is configured to determine an operational state of the aircraft based on at least one of a configuration of the aircraft and an atmospheric condition and vary the audible volume at which the audible indication is provided to the operator based at least in part on said determined operational state of the aircraft.

### BRIEF DESCRIPTION OF THE DRAWINGS

The present invention will hereinafter be described in conjunction with the appended drawing figures, wherein like numerals denote like elements, and in which:

FIG. 1 is a block diagram schematically illustrating a vehicle including a flight deck and a avionics/flight system;

FIG. 2 is a block diagram of a navigation and control subsystem within the avionics/flight system illustrated in FIG. 1;

FIG. 3 is a block diagram of a system and/or method for adjusting the volume of an audible indication according to one embodiment of the present invention; and

FIG. 4 is a graphical comparison of ambient noise levels present on a flight deck and predetermined gain factors applied to aural warning signals.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. In this regard, the present invention may be described in terms of functional block diagrams and various processing steps. It should be appreciated that such functional blocks may be realized in many different forms of hardware, firmware, and/or software components configured to perform the various functions. For example, the present invention may employ various integrated circuit components, e.g., memory elements, digital signal processing elements, look-up tables, and the like, which may carry out a variety of functions under the control of one or more microprocessors or other control devices. Such general techniques are known to those skilled in the art and are not described in detail herein. Moreover, it should be understood that the exemplary process illustrated may include additional or fewer steps or may be performed in the context of a larger processing scheme. Furthermore, the various methods presented in the drawing Figures or the specification are not to be construed as limiting the order in which the individual processing steps may be performed. It should be appreciated that the particular implementations shown and described herein are illustrative of the invention and its best mode and are not intended to otherwise limit the scope of the invention in any way.

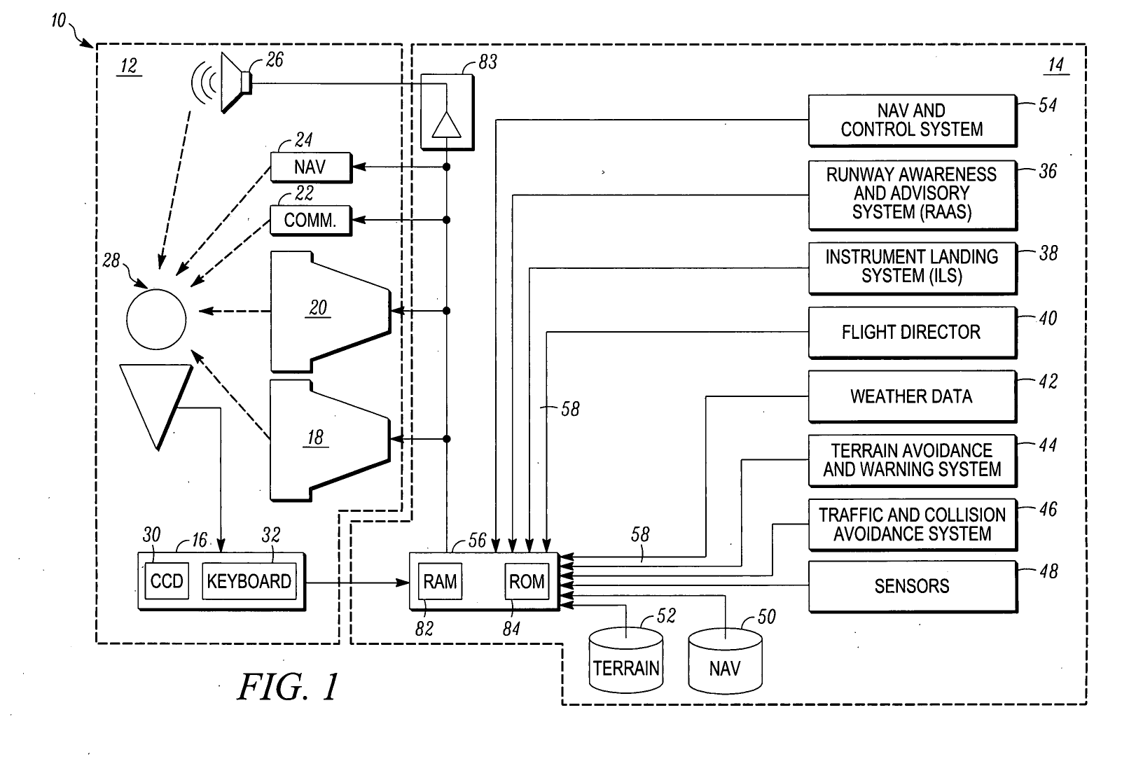

FIG. 1 schematically illustrates a vehicle 10, such as an aircraft, according to one embodiment of the present invention. The vehicle 10 may be, in one embodiment, any one of a number of different types of aircraft such as, for example, a private propeller or jet engine driven airplane, a commercial jet liner, or a helicopter. In the depicted embodiment, the vehicle 10 includes a flight deck 12 (or cockpit) and an avionics/flight system 14. Although not specifically illustrated, it should be understood that the vehicle 10 also includes a frame or body to which the flight deck 12 and the avionics/flight system 14 are connected, as is commonly understood. It should also be noted that vehicle 10 is merely exemplary and could be implemented without one or more of the depicted components, systems, and data sources. It will additionally be appreciated that the vehicle 10 could be implemented with one or more additional components, systems, or data sources.

In one embodiment, the flight deck 12 includes a user interface 16, a plurality of display devices 18 and 20, a communications radio 22, a navigational radio 24, and an audio device 26. The user interface 16 is configured to receive input from a user 28 (e.g., a pilot) and, in response to the user input, supply command signals to the avionics/flight system 14. The user interface 16 may be any one, or combination, of various known user interface devices including, but not limited to, a cursor control device (CCD) 30, such as a mouse, a trackball, or joystick, and/or a keyboard, one or more buttons, switches, or knobs. In the depicted embodiment, the user interface 16 includes a CCD 30 and a keyboard 32. The user 28 uses the CCD 30 to, among other things, move a cursor symbol on the display screen, and may use the keyboard 32 to, among other things, input textual data.

Still referring to FIG. 1, the display devices 18 and 20 are each used to display various images and data, in a graphic, iconic, and a textual format, and to supply visual feedback to the user 28 in response to user input commands supplied by the user 28 to the user interface 16. It will be appreciated that the display devices 18 and 20 may each be implemented using any one of numerous known displays suitable for rendering image and/or text data in a format viewable by the user 28, such as a cathode ray tube (CRT) displays, a LCD (liquid crystal display), a TFT (thin film transistor) displays, or a heads up display (HUD) projection.

The communication radio 22 is used, as is commonly understood, to communicate with entities outside the vehicle 10, such as air-traffic controllers and pilots of other aircraft. Although not illustrated, the communications radio 22 may include a microphone and speaker, such as on a headset which the user 28 operates to receive and send vocal messages. The navigational radio 24 is used to receive from outside sources and communicate to the user various types of information regarding the location of the vehicle, such as Global Positioning Satellite (GPS) system and Automatic Direction Finder (ADF) (as described below).

The audio device 26 is, in one embodiment, an audio speaker mounted within the flight deck 12. As shown, the audio device 26 is, in one embodiment, separated from the communications radio 22 and the navigational radio 24, and thus provides an audio indication, or signal, separate from any information or messages being transmitted to the user via the communications radio 22 and/or the navigational radio 24. In another embodiment, the audio device 26 is a headet, similar to the headset used with the communications radio 22.

The avionics/flight system 14 includes a runway awareness and advisory system (RAAS) 36, an instrument landing system (ILS) 38, a flight director 40, a weather data source 42, a terrain avoidance warning system (TAWS) 44, a traffic and collision avoidance system (TCAS) 46, a plurality of sensors 48, one or more navigational databases 50, one or more terrain databases 52, a navigation and control system 54, and a processor 56. The various components of the avionics/flight system 14 are in operable communication via a data bus 58 (or avionics bus).

The RAAS 36 provides improved situational awareness to help lower the probability of runway incursions by providing timely aural advisories to the flight crew during taxi, takeoff, final approach, landing and rollout. The ILS 38 is a radio navigation system that provides aircraft with horizontal and vertical guidance just before and during landing and, at certain fixed points, indicates the distance to the reference point of landing. The flight director 40, as is generally known, supplies command data representative of commands for piloting the aircraft in response to flight crew entered data, or various inertial and avionics data received from external systems. The weather data source 42 provides data representative of at least the location and type of various weather cells. The TAWS 44 supplies data representative of the location of terrain that may be a threat to the aircraft, and the TCAS 46 supplies data representative of other aircraft in the vicinity, which may include, for example, speed, direction, altitude, and altitude trend. Although not illustrated, the sensors 48 may include, for example, a barometric pressure sensor, a thermometer, and a wind speed sensor.

The navigation databases 50 include various types of navigation-related data, and the terrain databases 52 include various types of data representative of the terrain over which the aircraft may fly. These navigation-related data include various flight plan related data such as, for example, waypoints, distances between waypoints, headings between waypoints, data related to different airports, navigational aids, obstructions, special use airspace, political boundaries, communication frequencies, and aircraft approach information.

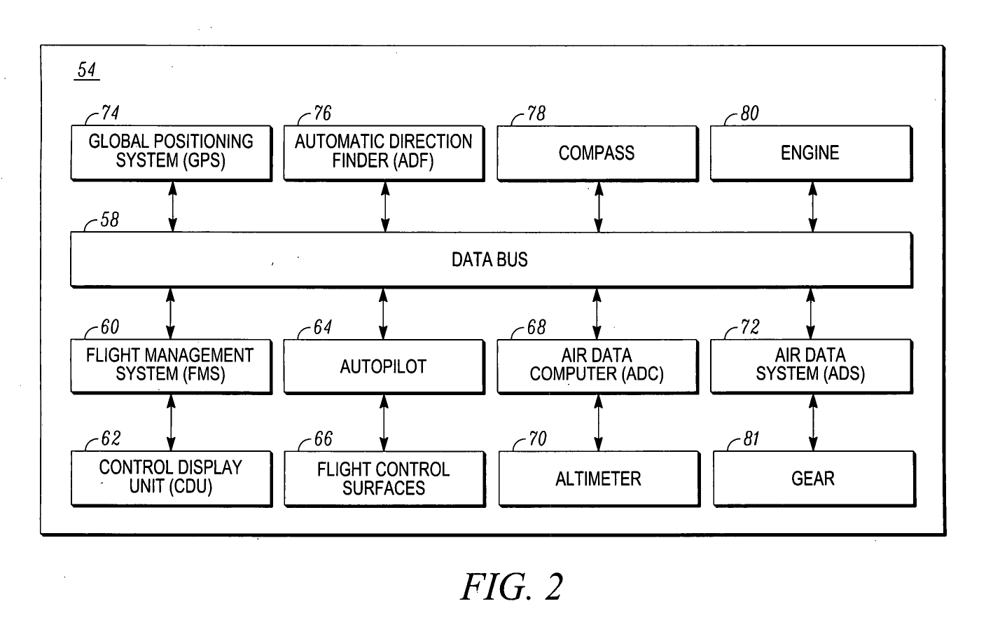

As illustrated in FIG. 2, the navigation and control system 54 includes a flight management system (FMS) 60, a control display unit (CDU) 62, an autopilot or automated guidance system 64, multiple flight control surfaces 66 (e.g., ailerons, elevators, and a rudder), an Air Data Computer (ADC) 68, an altimeter 70, an Air Data System (ADS) 72, a Global Positioning Satellite (GPS) system 74, an automatic direction (ADF) 76, a compass 78, at least one engine 80, and gear (i.e., landing gear) 81. Although not shown, the ADS 26 may include a pitostatic tube system, as is commonly understood in the art. The navigation and control system 54 may also incorporate the data bus 58, through which the various components of the navigation and control system 54, as well as the entire vehicle 10, may be in operable communication. It should be understood that the vehicle 10 shown in FIGS. 1 and 2 is merely of an example of an embodiment of the invention. As such, the vehicle 10 may include other components, system, and subsystems, as will be appreciated by one skilled in the art, such as military devices, such as weapons and targeting systems, and additional systems, such as a Ram Air Turbine (RAT) system.

Referring now to FIG. 1, the processor 56 may be any one of numerous known general-purpose microprocessors or an application specific processor that operates in response to program instructions. In the depicted embodiment, the processor 56 includes on-board RAM (random access memory) 82, and on-board ROM (read only memory) 84. The program instructions that control the processor 56 may be stored in either or both the RAM 82 and the ROM 84. For example, the operating system software may be stored in the ROM 84, whereas various operating mode software routines and various operational parameters may be stored in the RAM 82. It will be appreciated that this is merely exemplary of one scheme for storing operating system software and software routines, and that various other storage schemes may be implemented. It will also be appreciated that the processor 56 may be implemented using various other circuits, not just a programmable processor. For example, digital logic circuits and analog signal processing circuits could also be used.

Still referring to FIG. 1, the avionics/flight system 14 also includes a gain amplifier 83 electrically connected to the audio device 26 on the flight deck 12 and in operable communication with the processor 56.

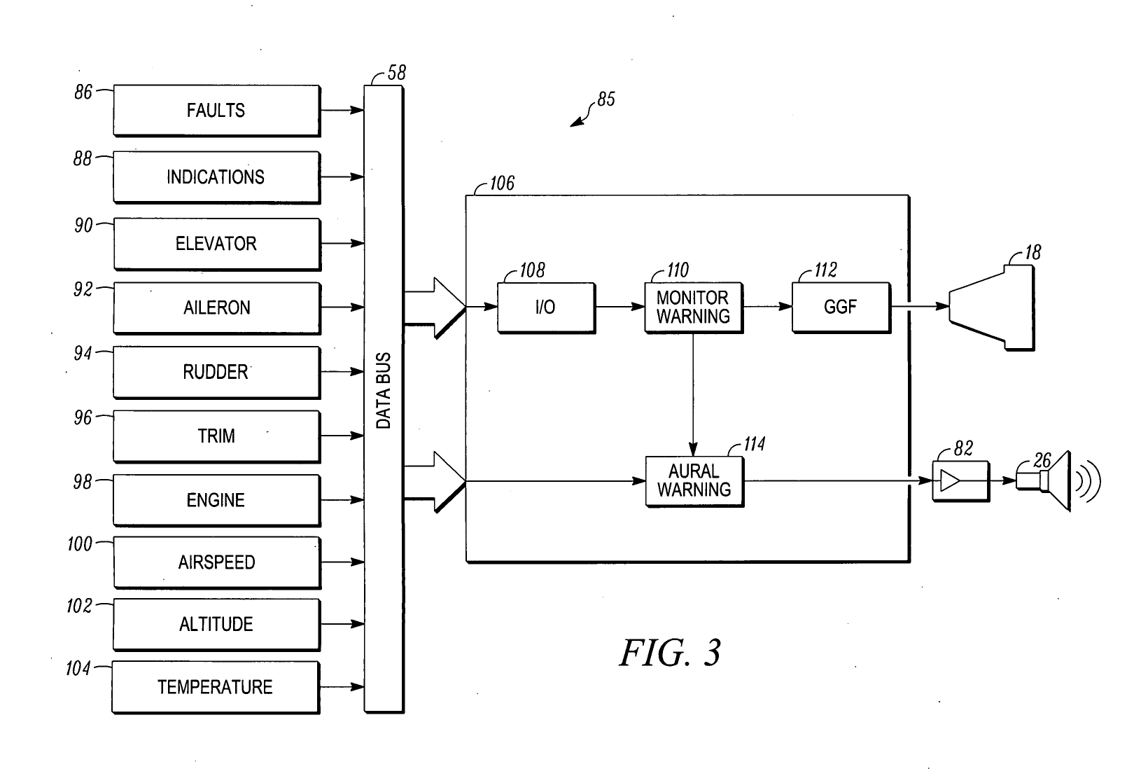

FIG. 3 illustrates a system and/or method 85 for adjusting the volume of an audible indication, according to one embodiment of the present invention. As shown, the method 85 incorporates the data bus 58, at least one of the displays 18, the gain amplifier 83 and the audio device 26, and further includes a variety of inputs 86-104 and a warning generator 106. In the depicted embodiment, the inputs include data representative of faults 86, indications 88, elevator position 90, aileron position 92, rudder position 94, trim 96, engine reading (e.g., actual power level or throttle) 98, airspeed 100, altitude 102, and air temperature 104. As will be appreciated by one skilled in the art, the various inputs 86-104 are generated by at least one of the respective components of the vehicle 10 illustrated in FIGS. 1 and 2. It should also be understood that the inputs 86-104 shown in FIG. 3 are intended to be merely an exemplary list of some of possible inputs that could be used and other inputs may be generated by other components of the vehicle 10 which are illustrated in FIGS. 1 and 2. Additionally, as suggested above, additional inputs may be provided by additional components of the vehicle 10 with are not illustrated in FIGS. 1 and 2, such as dynamic pressure and turbulence.

For example, the indications 88 may include data from the TAWS 44 concerning an elevation increase along the current flight path due to a mountain, or other terrain, or data from the TCAS 46 regarding the location of another aircraft. The elevator, aileron, and rudder positions 90, 92, and 94, may be readings from navigation and control system 54 indicating the positions of those respective flight control surfaces. The engine reading 98 may be an indication of the current throttle setting (e.g., half or full) of the engine 80. The engine reading 80, along with the positions of the flight control surfaces, may define a current configuration of the vehicle 10. The airspeed 100, the altitude 102, and the temperature 104 may be readings taken from various sensors on the vehicle, as is commonly understood. The readings from such sensors may define a current a current atmospheric condition (i.e., the condition of the portion of the atmosphere through which the vehicle 10 is currently traveling). The combination of the vehicle configuration and the atmospheric conditions may define a current or present operational state of the aircraft, as will be discussed in greater detail below.

The inputs 86-104 are each supplied, via the data bus 58, to the warning generator 106. The warning generator 106, which in one embodiment is implemented via instructions stored on a computer-readable medium accessible by the processor 56, includes an input/output (I/O) module 108, a monitor warning module 110, a graphics generator function (GGF) 112, and an aural warnings module 114. The I/O module 108 includes a plurality of interfaces to receive the various signals and data from the other components of the vehicle and to send the appropriate information to the monitor warning module 110. The monitor warning module 110 monitors the inputs 86-104 for situations (e.g., faults 86 and indications 88) that indicate that an appropriate warning should be provided to the user 28 of the vehicle 10. When such a condition occurs, the monitor warning module 110 sends an appropriate signal to the GGF 112 which generates an appropriate visual warning that is sent to, and displayed by, the display device 18 (and/or 20). As will be appreciated by one skilled in the art, some warning situations will result in both visual and audio warnings (or aural warnings) being provided to the user 28. Examples of such warning situations include, but are not limited to, an autopilot disconnect, overspeed, engine failure, low fuel, fire, and low altitude.

In a situation in which an aural warning is supplied, the monitor warning module 110 also sends an appropriate signal to the aural warning module 114. As will be appreciated by one skilled in the art, the aural warning module 114 generates an appropriate aural warning signal based on the inputs 86-104. The aural warning signal is then sent to the gain amplifier 83, which applies a gain, or gain factor, to the aural warning signal before sending the aural warning signal to the audio device. The audio device 26 receives the aural warning signal and emits an appropriate audible indication, or aural warning. For example, if the vehicle 10 is on approach for landing and is traveling at an undesirably high speed, the aural warning may be a repeated announciation of the word “overspeed.” Likewise, if the vehicle 10 is running low on fuel, the aural warning may be a repeated announciation of the word “low fuel.” The volume at which the aural warning is emitted from the audio device 26 is dependent upon the gain factor applied by the gain amplifier 83.

The aural warning module 114 also receives the various inputs 86-104 from the data bus 58 and signals the gain amplifier 83 to apply a specific, predetermined gain factor based on the current state of the vehicle 10. The current state of the vehicle 10 is determined by the combination of the particular inputs 86-104 that are present on the data bus 58. In one embodiment, the aural warning module 114 includes an algorithm that determines (or predicts) the ambient noise level present on the flight deck 12 based on the inputs 90-104. In another embodiment, the aural warning module 114 includes a database of measured ambient noise levels on the flight deck 12 for particular combinations of inputs 90-104. As will be appreciated by one skilled in the art, the measurements for the ambient noise levels on the flight deck may be taken during test flights of the type and model of aircraft. Of particular interest is that fact that, in at least one embodiment, the ambient noise level on the flight deck is not detected, such as via a microphone, but is rather calculated or determined by the current state of the vehicle 10.

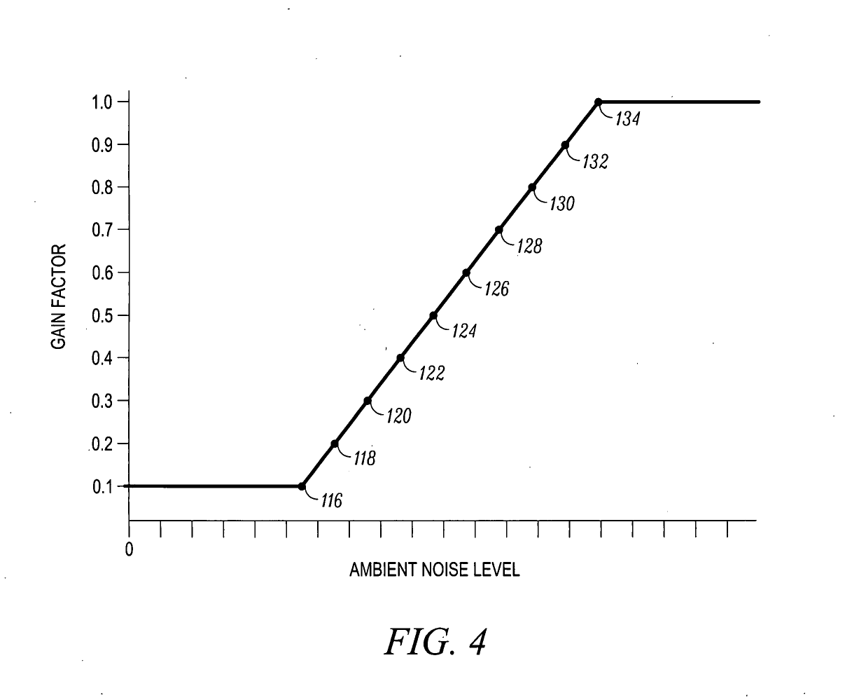

FIG. 4 graphically illustrates a comparison of ambient noise levels on the flight deck 12 and the gain factors applied by the gain amplifier 83. In the depicted embodiment, the gain amplifier 83 applies one of ten predetermined gain factors 116-134 depending on the ambient noise level on the flight deck. For relatively low levels of ambient noise, a minimum gain factor 116 is applied such that the aural warning is emitted from the audio device at a minimum volume, which because of the low ambient noise level on the flight deck 12, allows the user to hear the aural warning without the warning being uncomfortably loud. An example of a situation (e.g., combination of inputs 86-104 as illustrated in FIG. 3) with a low ambient noise level is the aircraft being on the ground (i.e., “weight on wheels) with the engine at a minimum, or idle, throttle setting.

However, for higher levels of ambient noise, the gain factor is increased based on the particular inputs 90-104 present on the data bus 58, and thus the determined state of the aircraft. One example of a situation, or aircraft state, with a high level of ambient noise is the aircraft flying at a high altitude, at full throttle, at a high speed. High ambient noise levels also occur, for example, during take off with the engines at full throttle and the flaps of the aircraft completely activated. In such situations, the gain factor is appropriate increased such that the aural warning is emitted on the flight deck at a volume sufficient for the warning to be heard by the user.

In one embodiment, as the determined ambient noise level increases, the gain factor is automatically increased to the next predetermined level. That is, for an ambient noise level that falls between gain factor 122 and gain factor 124, gain factor 124 is automatically applied, as opposed to applying a gain factor that is greater than gain factor 122 but less than gain factor 124. As such, as the gain factor, as well as the volume of the aural warning, increases as a series of steps as the ambient noise level increases to further ensure that the aural warning is at a volume sufficient to be heard by the pilot over the ambient noise on the flight deck 12.

One advantage of the system and method described above is that because the volume of the aural warnings is adjusted based on the ambient noise level on the flight deck, the aural warnings are sounded at volumes loud enough to be heard by the user over the ambient noise on the flight deck without being uncomfortably loud when the ambient noise on the flight deck is low. As a result, the comfort level of the user is improved. Another advantage is that because the gain factors, and thus volumes of the aural warnings, are set at predetermined levels based on the ambient noise level on the flight deck, the possibility that the user could tamper with the volume settings of the aural warnings is reduced. A further advantage is that because the volume of the aural warnings is adjusted without actively detecting the ambient noise level in the cockpit, the reliability of the system is improved.

Other embodiments may be utilized in vehicles other than aircraft, such as automobiles and watercraft. It should also be understood that the audio indication provided by the audio device is not intended to be limited to warnings, but may be any audible signal that is intended to be heard by a user of the vehicle regardless of the situation.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A method for providing an audible indication to an operator of a vehicle at an audible volume comprising the steps of:
determining an operational state of the vehicle; and
varying the audible volume at which the audible indication is provided to the operator based at least in part on said determined operational state of the vehicle.

2. The method of claim 1, wherein the vehicle is an aircraft and said determination of the operational state is based on at least one of a configuration of the aircraft and an atmospheric condition.

3. The method of claim 2, wherein the configuration of the vehicle comprises at least one of an airspeed, an elevator position, an aileron position, a rudder position, a trim, a flap position, a slat position, an airbrake position, a landing gear position, and an engine power level.

4. The method of claim 3, wherein the atmospheric condition comprises at least one of aircraft altitude, aircraft airspeed, dynamic pressure, turbulence, barometric pressure, temperature, and humidity.

5. The method of claim 3, wherein the audible indication is an aural warning.

6. The method of claim 5, wherein the audible indication is provided by a speaker mounted on a flight deck of the aircraft.

7. The method of claim 6, further comprising:
providing the audible indication to the operator at a first volume if said determined operational state is a first state;
providing the audible indication to the operator at a second volume if said determined operational state is a second state; and
providing the audible indication to the operator at a third volume if said determined state is a third state.

8. The method of claim 7, wherein the first state is indicative of a predicted first ambient noise level on the flight deck of the aircraft, the second state is indicative of a predicted second ambient noise level on the flight deck of the aircraft, and the third state is indicative of a predicted third ambient noise level on the flight deck of the aircraft.

9. The method of claim 8, wherein the first, second, and third volumes are provided by applying first, second, and third predetermined gains to an audio signal provided to the speaker.

10. The method of claim 9, wherein said determination of the state of the aircraft is not based on a detection of an existing ambient noise level on the flight deck of the aircraft.

11. A method for providing an aural warning to an operator of an aircraft comprising:
predicting an ambient noise level on a flight deck of an aircraft based on at least one of an airspeed, an elevator position, an aileron position, a rudder position, a trim, a flap position, a slat position, an airbrake position, a landing gear position, engine throttle, an altitude of the aircraft, barometric pressure, airspeed, turbulence, temperature, and humidity;
detecting an aural warning condition of the aircraft;
providing an aural warning signal to an audio device mounted within the flight deck of the aircraft;
applying a first predetermined gain to the aural warning signal such that the aural warning is emitted from the speaker and provided to the operator at a first volume if said predicted ambient noise level is a first ambient noise level; and
applying a second predetermined gain to the aural warning signal such that the aural warning is emitted from the audio device speaker and provided to the operator at a second volume if said predicted ambient noise level is a second ambient noise level.

12. The method of claim 11, further comprising applying the second predetermined gain to the aural warning signal such that the aural warning is emitted from the audio device and provided to the operator at the second volume if said determined ambient noise level is greater than the first ambient noise level and less than the second ambient noise level.

13. The method of claim 12, further comprising applying a third predetermined gain to the aural warning signal such that the aural warning is emitted from the audio device and provided to the operator at a third volume if said predicted ambient noise level is a third ambient noise level.

14. The method of claim 13, further comprising applying the third predetermined gain to the aural warning signal such that the aural warning is emitted from the audio device and provided to the operator at the third volume if said predicted ambient noise level is greater than the second ambient noise level and less than the third ambient noise level.

15. The method of claim 14, wherein said prediction of the ambient noise level on the flight deck of the aircraft is not based on a detection of an existing ambient noise level on the flight deck.

16. An avionics system comprising:
an audio device mounted on a flight deck of an aircraft to provide an audible indication to an operator of the aircraft;
a gain amplifier coupled to the audio device to provide a gain to an audio signal provided to the speaker; and
a processor in operable communication with the audio device and the gain amplifier, the processor being configured to:
determine an operational state of the aircraft based on at least one of a configuration of the aircraft and an atmospheric condition; and
vary the audible volume at which the audible indication is provided to the operator based at least in part on said determined operational state of the aircraft.

17. The avionics system of claim 16, wherein the configuration of the aircraft comprises at least one of an airspeed, an elevator position, an aileron position, a rudder position, a trim, a flap position, a slat position, an airbrake position, a landing gear position, and engine throttle and the atmospheric condition comprises at least one an altitude of the aircraft, dynamic pressure, turbulence, barometric pressure, temperature, and humidity.

18. The avionics system of claim 17, wherein the processor is further configured to:
apply a first predetermined gain to the audio signal such that the audible indication is emitted from the audio device and provided to the operator at a first volume if said determined operational state is a first state;
apply a second predetermined gain to the audio signal such that the audible indication is emitted from the audio device and provided to the operator at a second volume if said determined operational state is a second state; and
apply a third predetermined gain to the audio signal such that the audible indication is emitted from the audio device and provided to the operator at a third volume if said determined operational state is a third state.

19. The avionics system of claim 18, wherein the first state is indicative of a first predicted ambient noise level on the flight deck of the aircraft, the second state is indicative of a second predicted ambient noise level on the flight deck of the aircraft, and the third state is indicative of a third predicted ambient noise level on the flight deck of the aircraft.

20. The avionics system of claim 19, wherein the processor is further configured to:
apply the second predetermined gain to the audio signal such that the audio indication is emitted from the audio device and provided to the operator at the second volume if said determined operational state is indicative of an ambient noise level that is greater than the first predicted ambient noise level and less than the second predicted ambient noise level; and
apply the third predetermined gain to the audio signal such that the audio indication is emitted from the audio device and provided to the operator at the third volume if said determined operational state is indicative of an ambient noise level that is greater than the second predicted ambient noise level and less than the third predicted ambient noise level.
